(19) United States
(12) Patent Application Publication
(10) Pub. No.: US 2010/0097270 A1
(43) Pub. Date: Apr. 22, 2010

(54) RECEIVING APPARATUS, MOVING ANGLE ESTIMATION METHOD, PROGRAM AND WIRELESS COMMUNICATION SYSTEM

(75) Inventor: Hiroyuki FUKADA, Tokyo (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: SONY CORPORATION, Tokyo (JP)

(21) Appl. No.: 12/572,466

(22) Filed: Oct. 2, 2009

(30) Foreign Application Priority Data
Oct. 17, 2008 (JP) 2008-268137

(51) Int. Cl. G01S 5/04

(52) U.S. Cl. 342/442

(57) ABSTRACT

A receiving apparatus is provided that includes a plurality of antennas, a phase difference calculation unit to calculate a phase difference of a received signal between the plurality of antennas, a difference calculation unit to calculate a difference between the phase difference of a previous received signal and the phase difference of a new received signal calculated by the phase difference calculation unit, and a moving angle estimation unit to estimate a moving angle of a transmitting apparatus from the difference in phase difference calculated by the difference calculation unit.

### BACKGROUND OF THE INVENTION

1. Field of the Invention

The present invention relates a receiving apparatus, a moving angle estimation method, a program and a wireless communication system.

2. Description of the Related Art

A receiving apparatus that includes a plurality of antennas and estimates an arrival angle of a signal from a phase difference of a carrier between the plurality of antennas has been proposed. Because the phase difference of a carrier between the plurality of antennas and the arrival angle are not in one-to-one correspondence if the interval of the plurality of antennas is equal to or longer than a half-wavelength of a carrier, the interval of the plurality of antennas is generally designed to be equal to or shorter than a half-wavelength of a carrier. Therefore, constraints are imposed on the placement of antennas in a receiving apparatus that includes three or more antennas, for example.

On the other hand, as the interval of the plurality of antennas is longer, a change in the phase difference of a carrier with respect to a change in the arrival angle is larger, so that detection sensitivity with respect to a change in the arrival angle improves. Therefore, by increasing the number of antennas mounted on a receiving apparatus, it is possible to allow the interval of antennas to be a half-wavelength or shorter and improve the detection sensitivity. However, increasing the number of antennas results in an increase in apparatus size and costs.

Japanese Unexamined Patent Application Publication No. 2007-263986 discloses a direction detection apparatus that detects an arrival angle of a received signal by a combinational use of a phase difference of a received signal among a plurality of antennas and an imaging screen by an imaging device.

### SUMMARY OF THE INVENTION

However, although the direction detection apparatus according to related art can detect a moving angle of a transmitting apparatus from the amount of change in arrival angle, it needs the addition of the imaging device, which results in an increase in apparatus size and costs.

In light of the foregoing, it is desirable to provide a novel and improved receiving apparatus, moving angle estimation method, program and wireless communication system that enable estimation of a moving angle of a transmitting apparatus and reduction of constraints on the placement of antennas.

According to an embodiment of the present invention, there is provided a receiving apparatus that includes a plurality of antennas, a phase difference calculation unit to calculate a phase difference of a received signal between the plurality of antennas, a difference calculation unit to calculate a difference between the phase difference of a previous received signal and the phase difference of a new received signal calculated by the phase difference calculation unit, and a moving angle estimation unit to estimate a moving angle of a transmitting apparatus from the difference in phase difference calculated by the difference calculation unit.

The receiving apparatus may further include a signal generation unit to generate a control signal causing the transmitting apparatus to shorten a signal transmission interval if the difference in phase difference calculated by the difference calculation unit exceeds a threshold. Further, the signal generation unit may generate a control signal causing the transmitting apparatus to maximize a signal transmission interval within a setting range if the difference in phase difference calculated by the difference calculation unit is zero.

The receiving apparatus may further include a phase detection unit to detect a phase at a maximum value with the shortest delay time among maximum values of an impulse response of a transmission channel between the transmitting apparatus and the antennas with respect to each received signal by the plurality of antennas, and the phase difference calculation unit may calculate a difference in the phase of each received signal by the plurality of antennas detected by the phase detection unit.

The receiving apparatus may further include a relationship storage unit to store a relationship of the difference in phase difference calculated by the difference calculation unit, a wavelength of the received signal and the moving angle of the transmitting apparatus, and the moving angle estimation unit may estimate the moving angle of the transmitting apparatus from the relationship stored in the relationship storage unit, the difference in phase difference calculated by the difference calculation unit and the wavelength of the received signal.

The receiving apparatus may further include an integration unit to integrate the moving angle of the transmitting apparatus estimated by the moving angle estimation unit. The receiving apparatus may further include a signal generation unit to generate a control signal causing the transmitting apparatus to dynamically change a signal transmission interval according to a value of the difference in phase difference calculated by the difference calculation unit.

According to another embodiment of the present invention, there is provided a moving angle estimation method including the steps of calculating phase differences of respective received signals received by a plurality of antennas, calculating a difference between the phase difference of a previous received signal and the phase difference of a new received signal, and estimating a moving angle of a transmitting apparatus from the difference between the phase difference of the previous received signal and the phase difference of the new received signal.

According to another embodiment of the present invention, there is provided a program causing a computer to execute a method comprising the steps of calculating phase differences of respective received signals received by a plurality of antennas, calculating a difference between the phase difference of a previous received signal and the phase difference of a new received signal, and estimating a moving angle of a transmitting apparatus from the difference between the phase difference of the previous received signal and the phase difference of the new received signal.

According to another embodiment of the present invention, there is provided a wireless communication system that includes a transmitting apparatus and a receiving apparatus including a plurality of antennas, a phase difference calculation unit to calculate a phase difference of a received signal from the transmitting apparatus between the plurality of antennas, a difference calculation unit to calculate a difference between the phase difference of a previous received signal and the phase difference of a new received signal calculated by the phase difference calculation unit, and a moving angle estimation unit to estimate a moving angle of the transmitting apparatus from the difference in phase difference calculated by the difference calculation unit.

In a receiving apparatus, a moving angle estimation method, a program and a wireless communication system according to the embodiments of the present invention described above, it is possible to estimate a moving angle of a transmitting apparatus and reduce constraints on the placement of antennas.

### BRIEF DESCRIPTION OF THE DRAWINGS

FIG. 1 is an explanatory view showing the overall configuration of a wireless communication system according to a first embodiment of the present invention.

FIG. 2 is an explanatory view showing the relationship between a plurality of antennas and an arrival angle of a packet.

FIG. 3 is an explanatory view showing the relationship between a phase difference arg(β) and an arrival angle of a packet.

FIG. 4 is an explanatory view showing the gist of an embodiment of the present invention.

FIG. 5 is a functional block diagram showing the configuration of a receiving apparatus according to a first embodiment of the present invention.

FIG. 6 is a functional block diagram showing the configuration of a PHY signal processing unit.

FIG. 7 is an explanatory view showing the amplitude level of an impulse response of a transmission channel.

FIG. 8 is a functional block diagram showing the configuration of an estimation unit.

FIG. 9 is an explanatory view showing the relationship between a difference in antenna phase difference between packets and a packet transmission interval requested to a transmitting apparatus.

FIG. 10 is a flowchart showing the flow of a moving angle estimation method executed in the receiving apparatus according to the first embodiment.

FIG. 11 is an explanatory view showing an example of the placement of antennas in a receiving apparatus according to a second embodiment of the present invention.

FIG. 12 is a functional block diagram showing the configuration of an estimation unit of the receiving apparatus according to the second embodiment.

### DETAILED DESCRIPTION OF THE INVENTION

Hereinafter, preferred embodiments of the present invention will be described in detail with reference to the appended drawings. Note that, in this specification and the appended drawings, structural elements that have substantially the same function and structure are denoted with the same reference numerals, and repeated explanation of these structural elements is omitted.

Preferred embodiments of the present invention will be described in the following order:

1. First Embodiment
1.1 Wireless Communication System According to First Embodiment
1.2 Configuration of Receiving Apparatus According to First Embodiment
1.3 Operation of Receiving Apparatus According to First Embodiment

2. Second Embodiment

3. Summary and Supplementation

### 1. First Embodiment

### Wireless Communication System According to First Embodiment

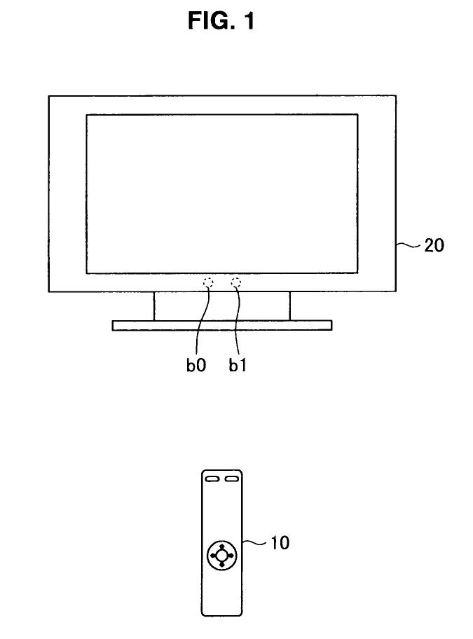

The overall structure and the gist of a wireless communication system 1 according to a first embodiment of the present invention are schematically described hereinafter with reference to FIGS. 1 to 4.

FIG. 1 is an explanatory view showing the overall structure of the wireless communication system 1 according to the first embodiment of the present invention. Referring to FIG. 1, the wireless communication system 1 includes a transmitting apparatus 10 and a receiving apparatus 20.

The transmitting apparatus 10 wirelessly transmits a packet in an intermittent manner. It is assumed in this embodiment that a user carries the transmitting apparatus 10 and spatially moves the transmitting apparatus 10. However, an object of movement is not limited to the transmitting apparatus 10, and it may be the receiving apparatus 20 or both the transmitting apparatus 10 and the receiving apparatus 20.

The receiving apparatus 20 includes a plurality of antennas b0 and b1 and receives a packet transmitted from the transmitting apparatus 10 by the antennas b0 and b1. The packet transmitted from the transmitting apparatus 10 may be a packet of a wireless LAN compliant to IEEE (Institute of Electrical and Electronic Engineers) 802.11a, b, g and n or the like, for example. FIG. 1 schematically shows the space between the plurality of antennas b0 and b1 by way of illustration only, and the plurality of antennas b0 and b1 may be actually in closer proximity than those shown in FIG. 1.

Further, although FIG. 1 illustrates a remote controller as an example of the transmitting apparatus 10 and illustrates a display device as an example of the receiving apparatus 20, the present embodiment is not limited thereto. For example, the transmitting apparatus 10 and the receiving apparatus 20 may be an information processing apparatus such as a PC (Personal Computer), a home video processing device, a PDA (Personal Digital Assistants), a home game machine, an electrical household appliance or the like. Further, the transmitting apparatus 10 and the receiving apparatus 20 may be an information processing apparatus such as a cellular phone, a PHS (Personal Handyphone System), a portable music playback device, a portable video processing device, a portable game machine or the like.

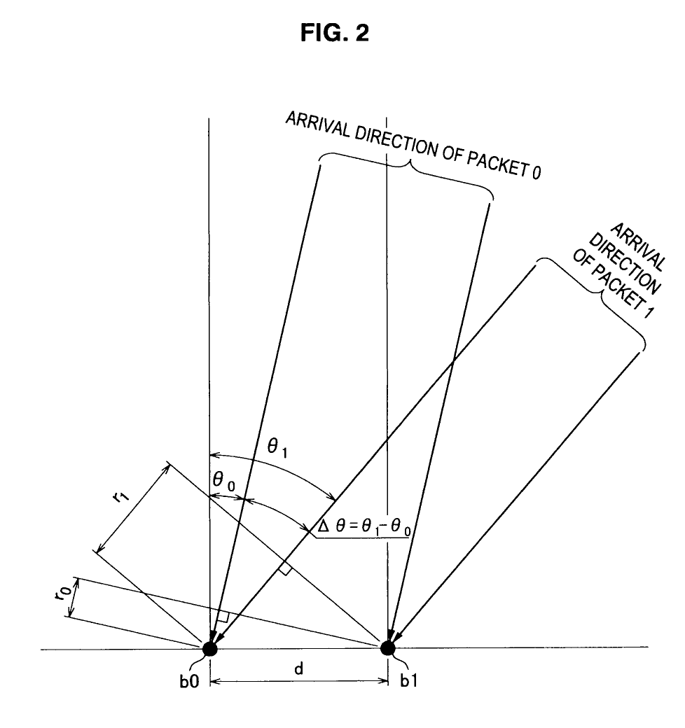

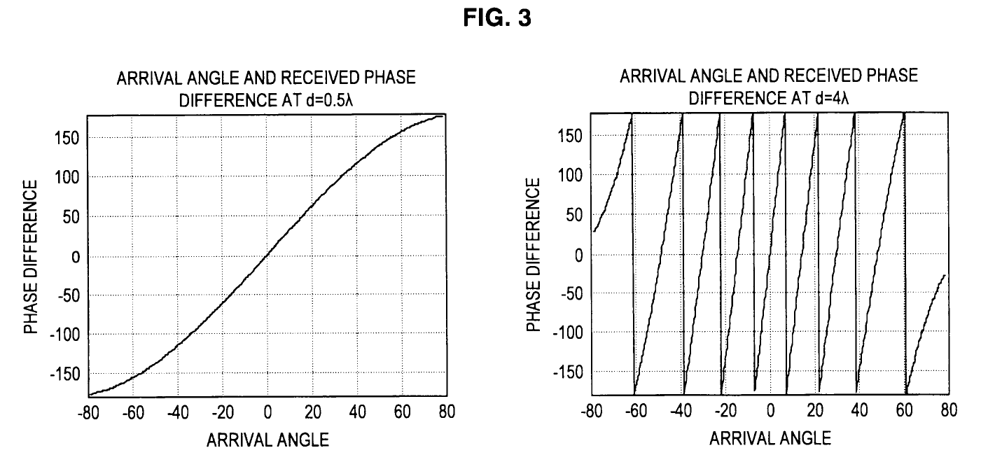

The relationship between an arrival angle of a packet viewed from the receiving apparatus 20 and a phase difference of a packet between the plurality of antennas b0 and b1 in the wireless communication system 1 is described hereinafter with reference to FIGS. 2 and 3.

FIG. 2 is an explanatory view showing the relationship between the plurality of antennas b0 and b1 and the arrival angle of a packet. In FIG. 2, d indicates a distance between the antennas b0 and b1, θ₀ indicates an arrival angle of a packet 0, and θ₁ indicates an arrival angle of a packet 1 (a packet subsequent to the packet 0). Further, in FIG. 2, r₀ indicates a difference between a distance until the packet 0 reaches the antenna b0 and a distance until the packet 0 reaches the antenna b1, and r₁ indicates a difference between a distance until the packet 1 reaches the antenna b0 and a distance until the packet 1 reaches the antenna b1. The values r₀ and rᵢ are represented by the following Expression 1:

r₀=d sin θ₀

r₁=d sin θ₁ Expression 1

Further, if received phase characteristics of the packet 0 in the antenna b0 are α_{0,0}, received phase characteristics of the packet 1 in the antenna b0 are α_{0,1}, received phase characteristics of the packet 0 in the antenna b1 are α_{1,0}, and received phase characteristics of the packet 1 in the antenna b1 are α_{1,1}, phase difference characteristics β₀ of the packet 0 between the antenna b0 and the antenna b1 and phase difference characteristics β₁ of the packet 1 between the antenna b0 and the antenna b1 are represented by the following Expression 2. Note that, a parameter called the term including “characteristics” such as received phase characteristics and phase difference characteristics is represented by a complex number and contains information related to a phase and amplitude.

β₀=α_{1,0}α_{0,0}*

β₁=α_{1,1}α_{0,1}* Expression 2

Further, argument arg(β₀) of phase difference characteristics β₀ and argument arg(β₁) of phase difference characteristics β₁ have a relationship represented by the following Expression 3 relative to r₀ and r₁, respectively, which are a channel difference between antennas. In Expression 3, λ indicates a carrier wavelength of a packet.

arg(β₀)=−2πr₀/λ

arg(β₁)=−2πr₁/λ Expression 3

By substitution of Expression 1 into Expression 3, the following Expression 4 is obtained.

arg(β₀)=−2π(d sin θ₀)λ

arg(β₁)=−2π(d sin θ₁)/λ Expression 4

As shown in Expression 4, if the distance d between the antenna b0 and the antenna b1 and the carrier wavelength λ are known, the arrival angle θ₀ of the packet 0 and the arrival angle θ₁ of the packet 1 can be estimated from the received phase characteristics β₀ and β₁. However, the relationship of the argument arg(β) of phase difference characteristics β, which is a phase difference arg(β) between antennas, and the arrival angle θ of a packet differs depending on the relationship of the distance d between the antenna b0 and the antenna b1 and the carrier wavelength λ as shown in FIG. 3.

FIG. 3 is an explanatory view showing the relationship of the phase difference arg(β) between antennas and the arrival angle θ of a packet. Specifically, the left part of FIG. 3 shows the relationship of the phase difference arg(β) between antennas and the arrival angle θ of a packet at a distance d=0.5λ, and the right part of FIG. 3 shows the relationship of the phase difference arg(β) between antennas and the arrival angle θ of a packet at a distance d=4.0λ.

As shown in the left part of FIG. 3, if distance d≦carrier wavelength λ/2, the phase difference arg(β) between antennas and the arrival angle θ of a packet are in one-to-one correspondence, and it is thus possible to accurately estimate the arrival angle θ of a packet from the phase difference arg(β) between antennas. On the other hand, as shown in the right part of FIG. 3, if distance d>carrier wavelength λ/2, the phase difference arg(β) between antennas and the arrival angle θ of a packet are not in one-to-one correspondence, and it is thus difficult to accurately estimate the arrival angle θ of a packet from the phase difference arg(β) between antennas.

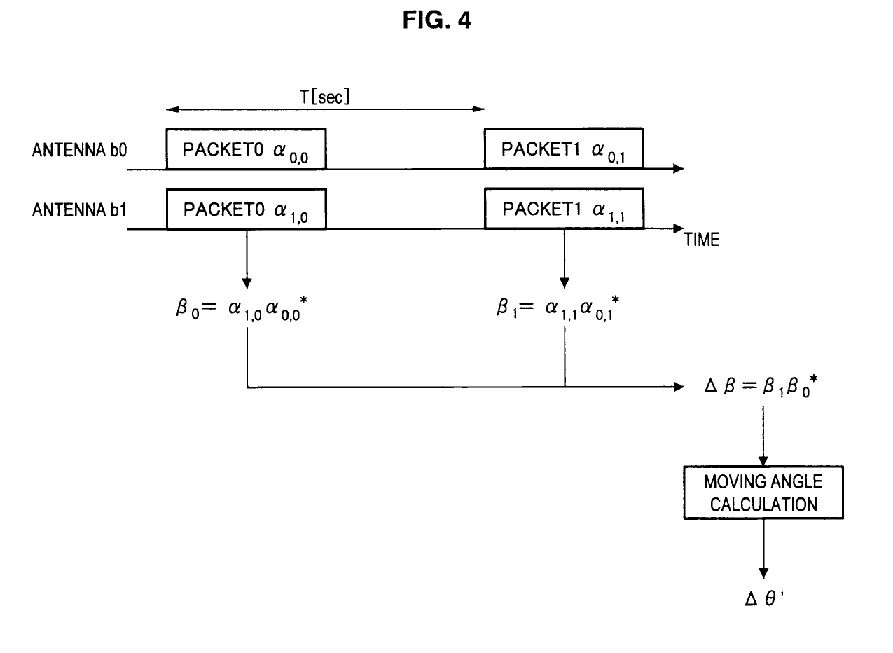

In this embodiment, however, it is possible to estimate a relative moving angle of the transmitting apparatus 10, which is a signal source, from the phase difference β₀ of the packet 0 between antennas and the phase difference β₁ of the packet 1 between antennas, regardless of whether the relationship of distance d≦carrier wavelength λ/2 is satisfied. The gist of the present embodiment is described hereinafter with reference to FIG. 4.

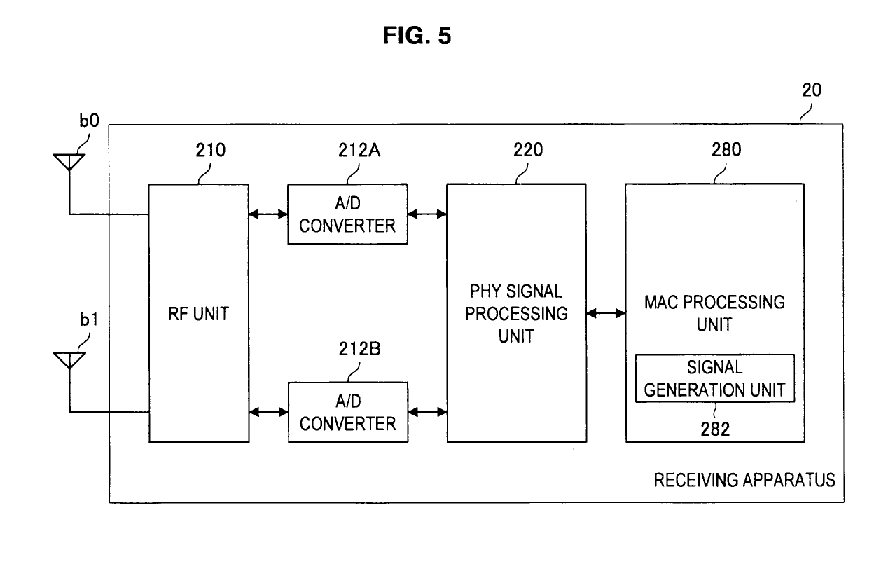

FIG. 4 is an explanatory view showing the gist of the present embodiment. As shown in FIG. 4, in this embodiment, a relative moving angle Δθ′ of the transmitting apparatus 10 is calculated from difference characteristics Δβ of the phase difference characteristics β₀ of the packet 0 between antennas and the phase difference characteristics β₁ of the packet 1 between antennas. However, if a difference arg(Δβ) in phase difference between packets exceeds ±π(rad), it is difficult to accurately estimate the relative moving angle Δθ′ of the transmitting apparatus 10. In light of this, in this embodiment, highly accurate estimation of the relative moving angle Δθ′ of the transmitting apparatus 10 is achieved by devising a method of preventing the difference arg(Δβ) in phase difference between packets from exceeding ±π(rad). The present embodiment that realizes such an effect is described hereinafter in detail with reference to FIGS. 5 to 10.

### 1.2 Configuration of Receiving Apparatus According to First Embodiment

FIG. 5 is a functional block diagram showing the configuration of the receiving apparatus 20 according to the first embodiment of the present invention. Referring to FIG. 5, the receiving apparatus 20 includes antennas b0 and b1, an RF unit 210, A/D converters 212A and 212B, a PHY signal processing unit 220 and a MAC processing unit 280. In the following description, each of a plurality of elements having substantially the same function is distinguished by affixing a different alphabetical letter to the same reference numeral. However, when there is no particular need to distinguish between a plurality of elements having the same function, they are denoted by the same reference numeral. For example, when there is no particular need to distinguish between the A/D converters 212A and 212B, they are collectively referred to simply as the A/D converter 212.

### (Receiving Function)

The RF (Radio Frequency) unit 210 converts each radio signal (received signal) of a packet received by the antennas b0 and b1 into an analog baseband signal and outputs the signal. For example, the radio signal received by the antennas b0 and b1 is input as a high-frequency signal to the RF unit 210. The RF unit 210 performs filtering of the input high-frequency signal and multiplies the high-frequency signal by a given frequency for down conversion, thereby converting the signal into an analog baseband signal.

The A/D converter 212A converts the analog baseband signal of the packet received by the antenna b0 that is input from the RF unit 210 into a digital baseband signal by sampling and quantization and outputs the signal. Likewise, the A/D converter 212B converts the analog baseband signal of the packet received by the antenna b1 that is input from the RF unit 210 into a digital baseband signal by sampling and quantization and outputs the signal.

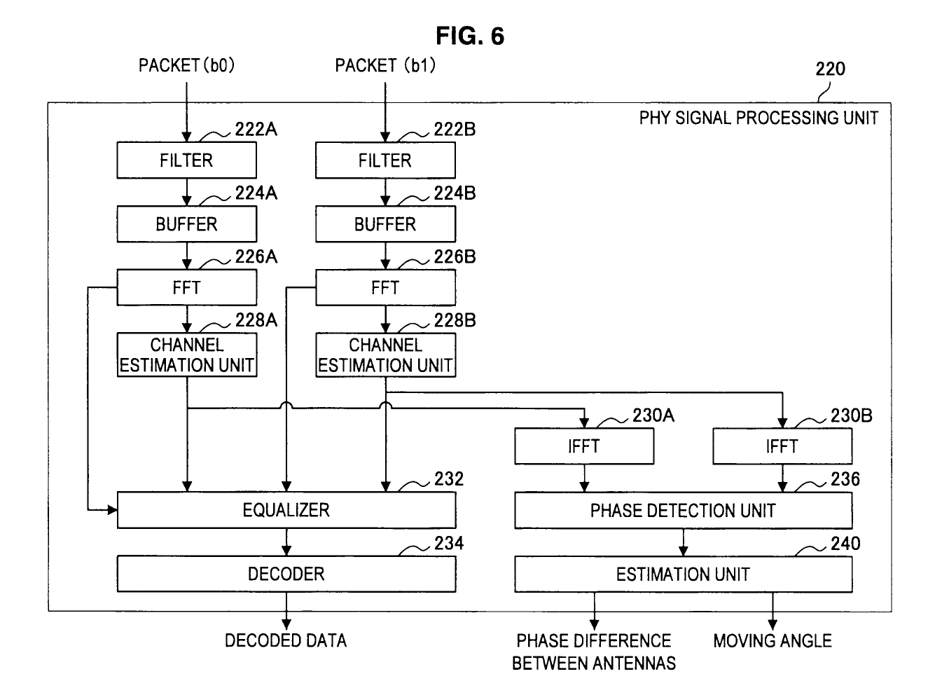

The PHY signal processing unit 220 performs demodulation and decoding of the digital baseband signal that is input from the A/D converter 212 and outputs decoded packet data. The detailed configuration of the PHY signal processing unit 220 is described later with reference to FIGS. 6 to 9.

The MAC processing unit 280 performs error detection, frame coupling or the like of data that is input from the PHY signal processing unit 220. Further, the MAC processing unit 280 includes a signal generation unit 282, and the signal generation unit 282 generates a control signal to be transmitted to the transmitting apparatus 10. The control signal contains information designating the transmission interval of packets to the transmitting apparatus 10.

### (Transmitting Function)

The PHY signal processing unit 220 converts data that is input from the MAC processing unit 280 into a digital baseband signal and outputs the signal. The PHY signal processing unit 220 may convert the input data into two-sequence digital baseband signals for implementing MIMO (Multi-Input Multi-Output) transmission.

The A/D converter 212 converts the digital baseband signal that is input from the PHY signal processing unit 220 into an analog baseband signal and outputs the signal. In the case of normal transmission, either the A/D converter 212A or the A/D converter 212B is used, and in the case of MIMO transmission, both the A/D converter 212A and the A/D converter 212B are used.

The RF unit 210 converts the analog baseband signal that is input from the A/D converter 212 into a high-frequency signal and transmits the signal as a radio signal from the antenna b. In the case of normal transmission, either the antenna b0 or the antenna b1 is used, and in the case of MIMO transmission, both the antenna b0 and the antenna b1 are used.

Referring then to FIG. 6, the configuration of the PHY signal processing unit 220 is described in further detail. Although the function of the PHY signal processing unit 220 at the time of reception is described below, the PHY signal processing unit 220 also has a signal processing function for packet transmission.

FIG. 6 is a functional block diagram showing the configuration of the PHY signal processing unit 220. Referring to FIG. 6, the PHY signal processing unit 220 includes filters 222A and 222B, buffers 224A and 224B, FFTs 226A and 226B, channel estimation units 228A and 228B, and IFFTs 230A and 230B. The PHY signal processing unit 220 also includes an equalizer 232, a decoder 234, a phase detection unit 236 and an estimation unit 240.

A baseband signal of a packet received by the antenna b0 is input to the filter 222A, and the filter 222A performs filtering for removing an unnecessary frequency component from the input baseband signal. Likewise, a baseband signal of a packet received by the antenna b1 is input to the filter 222B, and the filter 222B performs filtering for removing an unnecessary frequency component from the input baseband signal.

The buffer 224A temporarily stores the baseband signal filtered by the filter 222A, and the buffer 224B temporarily stores the baseband signal filtered by the filter 222B.

The FFT (Fast Fourier Transform) 226A performs FFT of the baseband signal stored in the buffer 224A with respect to each OFDM (Orthogonal frequency-division multiplexing) symbol. Likewise, the FFT 226B performs FFT of the baseband signal stored in the buffer 224B with respect to each OFDM symbol.

The channel estimation unit 228A measures transmission channel characteristics including between the transmitting apparatus 10 and the antenna b0 with respect to each subcarrier based on a signal component of each subcarrier that is obtained by the FFT 226A. For example, the channel estimation unit 228A may measure transmission channel characteristics of each subcarrier by a short training symbol or a long training symbol contained in a preamble of a packet. Likewise, the channel estimation unit 228B measures transmission channel characteristics including between the transmitting apparatus 10 and the antenna b1 with respect to each subcarrier based on a signal component of each subcarrier that is obtained by the FFT 226B.

The equalizer 232 performs channel equalization by removing a distortion component of a transmission channel based on the transmission channel characteristics estimated by the channel estimation unit 228A from the signal for each subcarrier that is input from the FFT 226A. Further, the equalizer 232 performs channel equalization by removing a distortion component of a transmission channel based on the transmission channel characteristics estimated by the channel estimation unit 228B from the signal for each subcarrier that is input from the FFT 226B. In the case where the receiving apparatus 20 performs MIMO reception, the equalizer 232 performs MIMO reception processing.

The decoder 234 performs demodulation and decoding of the signal for each subcarrier that is channel-equalized by the equalizer 232 and acquires decoded packet data. Then, the decoder 234 outputs the decoded packet data to the MAC processing unit 280.

The IFFT (Inverse FFT) 230A performs inverse fast Fourier transform on the transmission channel characteristics of each subcarrier input from the channel estimation unit 228A and thereby obtains an impulse response in the time domain of the transmission channel including between the transmitting apparatus 10 and the antenna b0. Likewise, the IFFT 230B performs inverse fast Fourier transform on the transmission channel characteristics of each subcarrier input from the channel estimation unit 228B and thereby obtains an impulse response in the time domain of the transmission channel including between the transmitting apparatus 10 and the antenna b1.

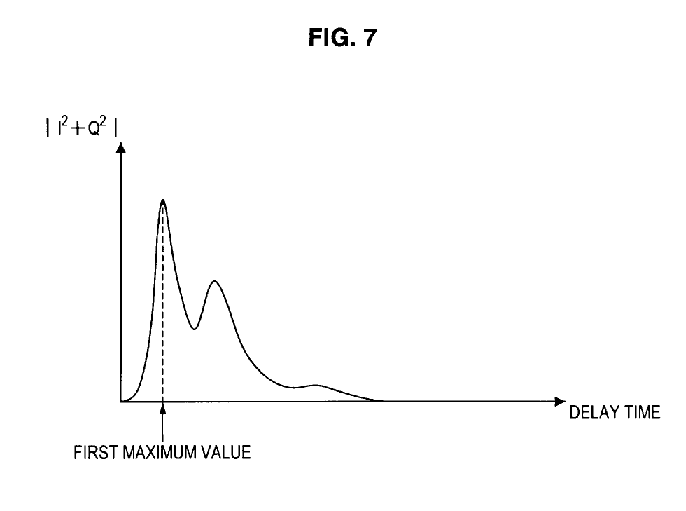

The phase detection unit 236 estimates phase characteristics of each direct wave of the packets received by the antennas b0 and b1 from the impulse response of the transmission channel obtained by the IFFTs 230A and 230B. FIG. 7 is an explanatory view showing the amplitude level of an impulse response of a transmission channel. Referring to FIG. 7, the amplitude level (|I²+Q²|) of an impulse response has a plurality of maximum values. Among them, the first maximum value with the shortest delay time is considered to correspond to a direct wave. Thus, the phase detection unit 236 searches for the maximum value with the shortest delay time among the maximum values of the amplitude level of an impulse response and detects complex receiving characteristics (I+jQ) at the maximum value as a signal having a phase angle of a received packet.

Specifically, the phase detection unit 236 searches for the maximum value with the shortest delay time among the maximum values of the amplitude level of an impulse response that is obtained by the IFFT 230A and detects phase characteristics α₀ at the maximum value as phase characteristics of a received packet by the antenna b0. Likewise, the phase detection unit 236 searches for the maximum value with the shortest delay time among the maximum values of the amplitude level of an impulse response that is obtained by the IFFT 230B and detects phase characteristics α₁ at the maximum value as phase characteristics of a received packet by the antenna b1.

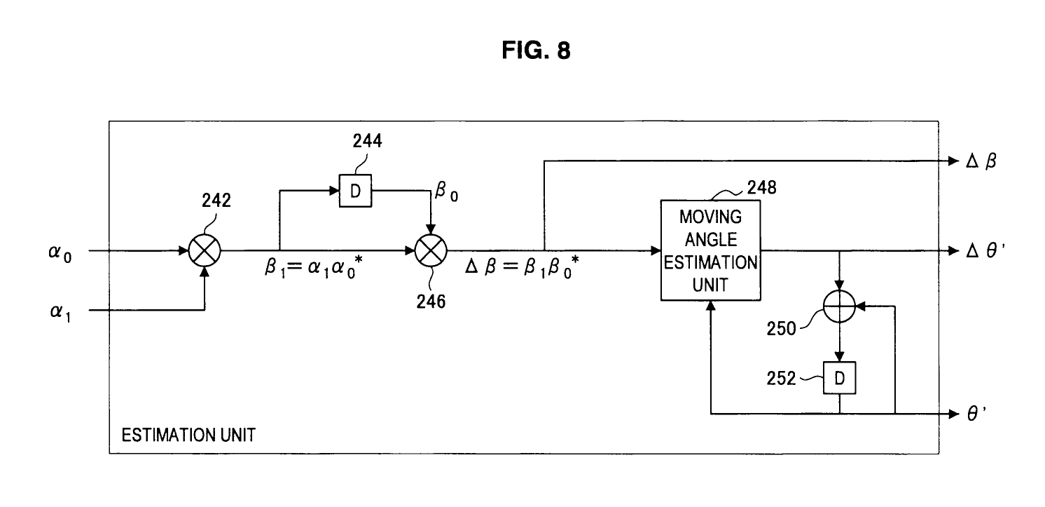

The estimation unit 240 estimates a relative moving angle of the transmitting apparatus 10 from the phase characteristics α₀ of a received packet by the antenna b0 and the phase characteristics α₁ of a received packet by the antenna b1 detected by the phase detection unit 236. The moving angle in this embodiment is an angle with a rotation axis being perpendicular to the separation direction of the antennas b0 and b1. The configuration of the estimation unit 240 is described hereinafter in detail with reference to FIG. 8.

FIG. 8 is a functional block diagram showing the configuration of the estimation unit 240. Referring to FIG. 8, the estimation unit 240 includes complex multiplication units 242 and 246, delay units 244 and 252, a moving angle estimation unit 248 and an addition unit 250.

The complex multiplication unit 242 functions as a phase difference calculation unit that calculates a phase difference β₁ of the packet 1 between antennas by multiplying complex conjugates of the phase αᵢ and the phase α₀. Phase difference characteristics that are calculated by the complex multiplication unit 242 are input to the delay unit 244, and the delay unit 244 delays the input phase difference characteristics and outputs a result. FIG. 8 shows an example in which the delay unit 244 delays the phase difference characteristics β₀ of the packet 0 between antennas calculated last time (previously) by the complex multiplication unit 242 and outputs a result.

The complex multiplication unit 246 functions as a difference calculation unit that calculates difference characteristics Δβ in phase difference between packets by multiplying complex conjugates of the phase difference characteristics β₁ of the packet 1 between antennas and the phase difference characteristics β₀ of the packet 0 between antennas.

The moving angle estimation unit 248 estimates the relative moving angle Δθ′ of the transmitting apparatus 10 based on the difference characteristics Δβ in phase difference between packets and the arrival angle θ′ of the previous packet 0. The difference characteristics Δβ in phase difference between packets, the arrival angle θ′ of the previous packet 0 and the moving angle Δθ′ are represented by the following Expression 5, for example.

$$\frac{Δ β}{\vert Δ β \vert} = {e}^{- j π ( d si n ( {θ}^{′} + Δ {θ}^{′} ) - d s i n {θ}^{′} ) / λ} \qquad Expression 5$$

The moving angle estimation unit 248 can estimate the relative moving angle Δθ′ of the transmitting apparatus 10 by substituting the difference characteristics Δβ in phase difference between packets and the arrival angle θ′ of the previous packet 0 into the above Expression 5. The moving angle estimation unit 248 (relationship storage unit) may store a table indicating the relationship of the difference Δβ in phase difference between packets, the arrival angle θ′ of the previous packet 0, the carrier wavelength λ and so on. The moving angle estimation unit 248 may estimate the relative moving angle Δθ′ of the transmitting apparatus 10 by referring to the table.

The moving angle Δθ′ that is estimated by the moving angle estimation unit 248 is used as user operation to the receiving apparatus 20 or an application device (e.g. a game machine) connected to the receiving apparatus 20.

Further, the arrival angle θ′ of the previous packet 0 is added to the moving angle Δθ′ estimated by the moving angle estimation unit 248 by the addition unit 250 and thereby updated to the arrival angle θ′ of the packet 1. Thus, the addition unit 250 functions as an integration unit that cumulatively adds the past arrival angles θ′ and calculates the arrival angle θ′. The arrival angle θ′ of the packet 1 is delayed by the delay unit 252 and output to be used for estimation of the moving angle Δθ′ of the packet 2 by the moving angle estimation unit 248.

Although the case where the arrival angle θ′ of the previous packet 0 is used as shown in Expression 5 when estimating the moving angle Δθ′ is described above, the present embodiment is not limited thereto. For example, if the moving angle Δθ′ and the arrival angle θ′ are very close to 0, it can be approximated by x=sinx. Thus, by substituting the above Expression 5 with the following Expression 6, the need for the arrival angle θ′ of the previous packet 0 may be eliminated when estimating the moving angle Δθ′.

$$\frac{Δ β}{\vert Δ β \vert} = {e}^{- jπ d si n Δ {θ}^{′} / λ} \qquad Expression 6$$

Further, in the case of using the arrival angle θ′ of the previous packet 0 as shown in Expression 5 when estimating the moving angle Δθ′, an initial value of the arrival angle θ′ can be specified by an arbitrary method. For example, the moving angle estimation unit 248 may specify the arrival angle θ′ of a packet upon startup as the initial value 0, or specify the arrival angle θ′ of a packet upon given operation by a user as the initial value 0.

As described above, according to this embodiment, it is possible to estimate the moving angle of the transmitting apparatus 10 based on the phase difference characteristics β₀ and β₁ between antennas. However, if the difference arg(Δβ) in phase difference between packets which is generated by the movement exceeds ±π(rad), it is difficult to accurately estimate the relative moving angle Δθ′ of the transmitting apparatus 10. In light of this, the receiving apparatus 20 according to the embodiment has the following function in order to prevent the difference arg(Δβ) in phase difference between packets from exceeding ±π(rad).

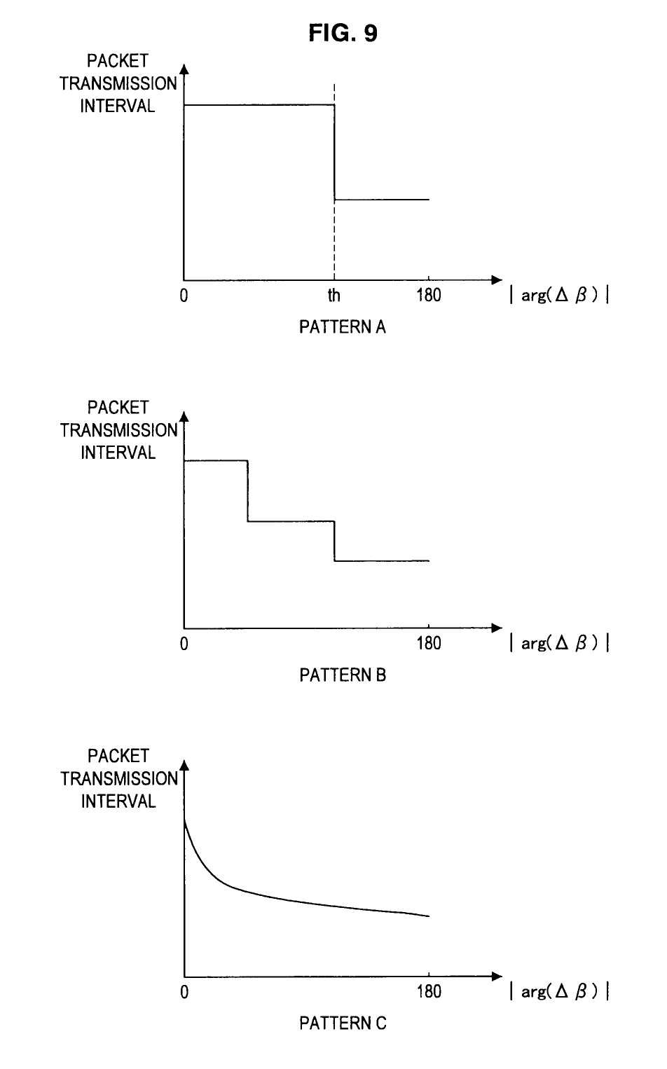

As shown in FIG. 8, the difference characteristics Δβ in antenna phase difference between packets are output to the MAC processing unit 280. The signal generation unit 282 of the MAC processing unit 280 specifies a packet transmission interval to be requested to the transmitting apparatus 10 based on the argument |arg(Δβ)| of the difference characteristics Δβ in antenna phase difference between packets, which is a difference |arg(Δβ)| in antenna phase difference between packets, and generates a control signal containing description of the packet transmission interval. Then, the transmitting apparatus 10 transmits a packet at the packet transmission interval described in the control signal. The signal generation unit 282 may specify the packet transmission interval according to patterns shown in FIG. 9, for example.

FIG. 9 is an explanatory view showing the relationship between the difference |arg(Δβ)| in antenna phase difference between packets and the packet transmission interval requested to the transmitting apparatus 10. In the pattern A, the transmission interval is constant until the difference |arg(Δβ)| in antenna phase difference between packets exceeds a prescribed threshold th, and the transmission interval is shortened when it exceeds the prescribed threshold th. Therefore, the difference βarg(Δβ)| in antenna phase difference between packets becomes smaller while an angular moving velocity of the transmitting apparatus 10 is the same, thereby preventing βarg(Δβ)| from exceeding ±π(rad).

In the pattern B, the transmission interval is shortened step by step as the difference βarg(Δβ)| in antenna phase difference between packets increases. When the difference βarg(Δβ)| in antenna phase difference between packets is 0, the transmitting apparatus 10 is not moving, and it is thus unlikely that |arg(Δβ)| exceeds ±π. Thus, as shown in the pattern B, if the difference |arg(Δβ)| in antenna phase difference between packets is 0, the maximum transmission interval within a setting range is applied, thereby preventing unnecessary transmission of a large amount of packets from the transmitting apparatus 10.

Further, as shown in the pattern C, the transmission interval may be shortened continuously as the difference |arg(Δβ)| in antenna phase difference between packets increases. Specifically, the pattern C shows the case where the shortened time of the transmission interval becomes smaller as the difference |arg(Δβ)| in antenna phase difference between packets increases. In the pattern C as well, it is possible to prevent a large amount of packets from being unnecessarily transmitted from the transmitting apparatus 10 and prevent the difference |arg(Δβ)| in antenna phase difference between packets from exceeding ±π(rad).

Although the case of dynamically varying the packet transmission interval in the transmitting apparatus 10 according to the difference |arg(Δβ)| in antenna phase difference between packets is described above, the present embodiment is not limited thereto. For example, the transmitting apparatus 10 may transmit a packet always at a transmission interval with which the difference βarg(Δβ)| in antenna phase difference does not exceed ±π(rad) even at the maximum angular moving velocity assumed in the transmitting apparatus 10.

Further, although the case where the receiving apparatus 20 designates a specific packet transmission interval to the transmitting apparatus 10 is described above, the present embodiment is not limited thereto. For example, the receiving apparatus 20 may transmit a control signal that simply designates the reduction of the packet transmission interval or a control signal that simply designates the elongation of the packet transmission interval.

Furthermore, although the case where the receiving apparatus 20 designates a packet transmission interval to the transmitting apparatus 10 is described above, the present embodiment is not limited thereto. For example, the receiving apparatus 20 may transmit a control signal containing description of the difference |arg(Δβ)| in antenna phase difference between packets to the transmitting apparatus 10, and the transmitting apparatus 10 may specify the transmission interval corresponding to the difference |arg(Δβ)| in antenna phase difference between packets.

### 1.3 Operation of Receiving Apparatus According to First Embodiment

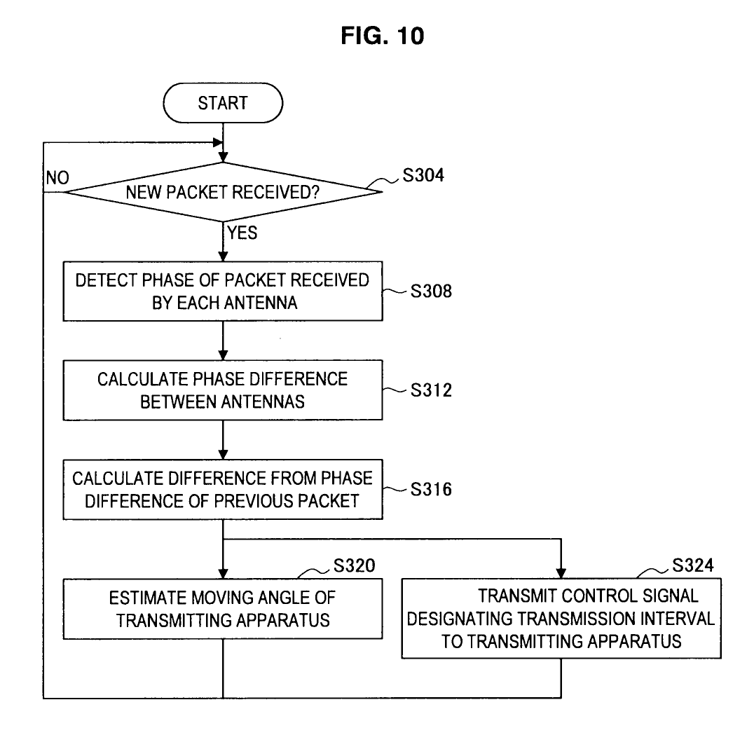

The configuration of the receiving apparatus 20 according to the embodiment is described in the foregoing with reference to FIGS. 5 to 9. In the following, a moving angle estimation method executed in the receiving apparatus 20 according to the embodiment is described with reference to FIG. 10.

FIG. 10 is a flowchart showing the flow of a moving angle estimation method executed in the receiving apparatus 20 according to the first embodiment. As shown in FIG. 10, if a new packet transmitted from the transmitting apparatus 10 is received by the antennas b0 and b1 (S304), the phase detection unit 236 detects the phase of the packet received by the antennas b0 and b1 (S308).

Then, the complex multiplication unit 242 of the estimation unit 240 calculates a phase difference of the packet received by the antennas b0 and b1 (S312), and the complex multiplication unit 246 calculates a difference between the phase difference and the phase difference of the previous packet (S316). Further, the moving angle estimation unit 248 estimates the moving angle of the transmitting apparatus 10 based on the difference in antenna phase difference between packets calculated by the complex multiplication unit 246 (S320).

On the other hand, the signal generation unit 282 of the MAC processing unit 280 specifies the packet transmission interval requested to the transmitting apparatus 10 according to the difference in antenna phase difference between packets calculated by the complex multiplication unit 246, and generates a control signal containing description of the transmission interval. The control signal generated by the signal generation unit 282 is transmitted to the transmitting apparatus 10 through the PHY signal processing unit 220, the A/D converters 212A and 212B, the RF unit 210 and the antennas b0 and b1 (S324). After that, the processing from the step S304 is repeated.

### 2. Second Embodiment

In the first embodiment described above, two antennas b0 and b1 are mounted on the receiving apparatus 20. The number of antennas mounted on the receiving apparatus 20, however, is not limited thereto. For example, the number of antennas may be three as in a receiving apparatus 20′ according to a second embodiment described hereinbelow.

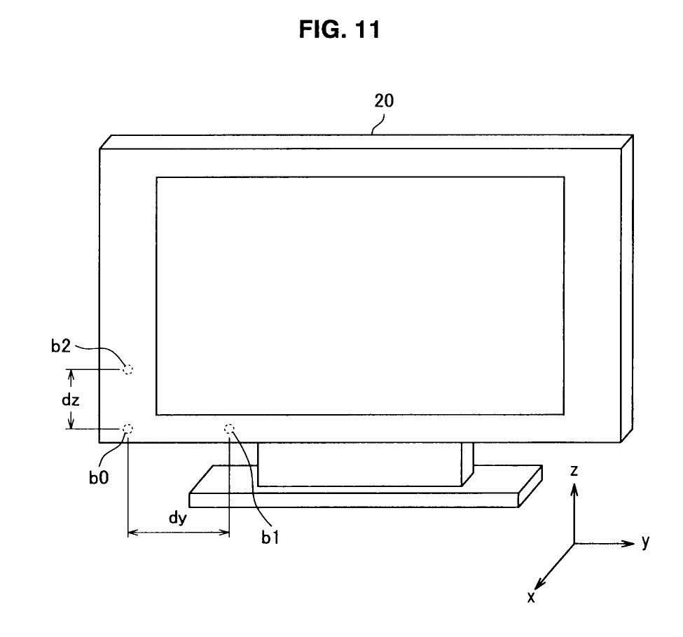

FIG. 11 is an explanatory view showing an example of the placement of antennas in the receiving apparatus 20′ according to the second embodiment of the present invention. Referring to FIG. 11, on the receiving apparatus 20′ according to the second embodiment, an antenna b1 is placed separated from an antenna b0 by a distance dy in the y-direction, and an antenna b2 is placed separated from the antenna b0 by a distance dz in the z-direction. FIG. 11 schematically shows the intervals among the plurality of antennas by way of illustration only, and the plurality of antennas may be actually in closer proximity than those shown in FIG. 11.

In this configuration, the receiving apparatus 20′ according to the second embodiment can estimate a moving angle with a rotation axis along the z-axis of the transmitting apparatus 10 based on a phase difference of a received packet by the antenna b1 and the antenna b0 which are placed separately in the y-direction. Further, the receiving apparatus 20′ according to the second embodiment can estimate a moving angle with a rotation axis along the y-axis of the transmitting apparatus 10 based on a phase difference of a received packet by the antenna b2 and the antenna b0 which are placed separately in the z-direction.

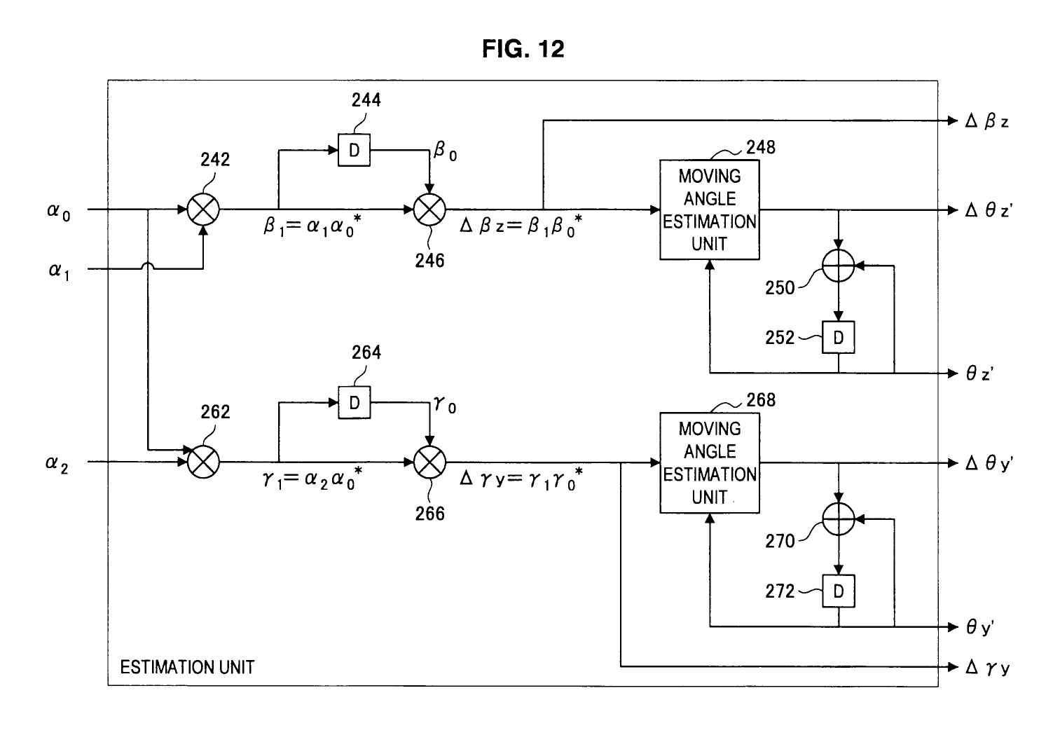

FIG. 12 is a functional block diagram showing the configuration of an estimation unit 240′ of the receiving apparatus 20′ according to the second embodiment. Referring to FIG. 12, the estimation unit 240′ includes complex multiplication units 242, 246, 262 and 266, delay units 244, 252, 264 and 272, moving angle estimation units 248 and 268, and addition units 250 and 270.

The complex multiplication unit 242 calculates phase difference characteristics β₁ of the packet 1 between the antenna b0 and the antenna b1 by multiplying complex conjugates of the phase characteristics α₁ of the received packet by the antenna b1 and the phase characteristics α₀ of the received packet by the antenna b0. A phase difference that is calculated by the complex multiplication unit 242 is input to the delay unit 244, and the delay unit 244 delays the input phase difference and outputs a result. FIG. 12 shows an example in which the delay unit 244 delays the phase difference β₀ of the packet 0 between antennas calculated last time (previously) by the complex multiplication unit 242 and outputs a result.

The complex multiplication unit 246 calculates difference characteristics Δβz in antenna phase difference between packets by multiplying complex conjugates of the phase difference characteristics β₁ of the packet 1 between antennas and the phase difference characteristics β₀ of the packet 0 between antennas.

The moving angle estimation unit 248 estimates the moving angle Δθz′ of the transmitting apparatus 10 based on the difference characteristics Δβz in antenna phase difference between packets and the arrival angle θz′ of the previous packet 0. The arrival angle θz′ and the moving angle Δθz′ are angles with a rotation axis along the z-axis shown in FIG. 11.

Further, the arrival angle θz′ of the previous packet 0 is added to the moving angle Δθz′ estimated by the moving angle estimation unit 248 by the addition unit 250 and thereby updated to the arrival angle θz′ of the packet 1. The arrival angle θz′ of the packet 1 is delayed by the delay unit 252 and output to be used for estimation of the moving angle Δθz′ of the packet 2 by the moving angle estimation unit 248.

Likewise, the complex multiplication unit 262 calculates phase difference characteristics γᵢ of the packet 1 between the antenna b0 and the antenna b2 by multiplying complex conjugates of the phase characteristics α₂ of the received packet by the antenna b2 and the phase characteristics α₀ of the received packet by the antenna b0. A phase difference that is calculated by the complex multiplication unit 262 is input to the delay unit 264, and the delay unit 264 delays the input phase difference and outputs a result. FIG. 12 shows an example in which the delay unit 264 delays the phase difference characteristics γ₀ of the packet 0 between antennas calculated last time (previously) by the complex multiplication unit 262 and outputs a result.

The complex multiplication unit 266 calculates difference characteristics Δγy in antenna phase difference between packets by multiplying complex conjugates of the phase difference characteristics γ₁ of the packet 1 between antennas and the phase difference characteristics γ₀ of the packet 0 between antennas.

The moving angle estimation unit 268 estimates the moving angle Δθy′ of the transmitting apparatus 10 based on the difference characteristics Δγy in antenna phase difference between packets and the arrival angle θy′ of the previous packet 0. The arrival angle θy′ and the moving angle Δθy′ are angles with a rotation axis along the y-axis shown in FIG. 11.

Further, the arrival angle θy′ of the previous packet 0 is added to the moving angle Δθy′ estimated by the moving angle estimation unit 268 by the addition unit 270 and thereby updated to the arrival angle θy′ of the packet 1. The arrival angle θy′ of the packet 1 is delayed by the delay unit 272 and output to be used for estimation of the moving angle Δθy′ of the packet 2 by the moving angle estimation unit 268.

As shown in FIG. 12, the difference characteristics Δβz and the difference characteristics Δγy in antenna phase difference between packets are output to the MAC processing unit 280. The signal generation unit 282 of the MAC processing unit 280 specifies a packet transmission interval to be requested to the transmitting apparatus 10 based on the argument of the difference characteristics Δβz and Δγy in antenna phase difference between packets and generates a control signal containing description of the packet transmission interval.

For example, in the second embodiment, the signal generation unit 282 may specify corresponding transmission intervals for both the difference characteristics Δβz and Δγy in antenna phase difference between packets and determine the shorter transmission interval as the transmission interval to be requested to the transmitting apparatus 10. In this configuration, it is possible to prevent the argument of the difference characteristics Δβz or Δγy in antenna phase difference between packets from exceeding ±π(rad) and highly accurately estimate the moving angle of the transmitting apparatus 10 in a plurality of directions.

### 3. Summary and Supplementation

As described in the foregoing, according to the embodiment, it is possible to detect the moving angle of the transmitting apparatus 10 regardless of the relationship of the distance between antennas and the carrier wavelength. It is thereby possible to increase the degree of freedom of the placement of antennas. Further, according to the embodiment, because the space between antennas can be enlarged, it is expected to improve the detection accuracy of the moving angle and the arrival angle of the transmitting apparatus 10. Furthermore, calibration between antennas is not necessary.

Further, according to the embodiment, the signal generation unit 282 specifies the packet transmission interval to be requested to the transmitting apparatus 10 based on the difference in antenna phase difference between packets and generate a control signal containing description of the packet transmission interval. In this configuration, it is possible to prevent a large amount of packets from being unnecessarily transmitted from the transmitting apparatus 10 and prevent the difference in antenna phase difference between packets from exceeding ±π(rad).

It should be understood by those skilled in the art that various modifications, combinations, sub-combinations and alterations may occur depending on design requirements and other factors insofar as they are within the scope of the appended claims or the equivalents thereof.

For example, it is not necessary to perform each step in the processing of the receiving apparatus 20 in chronological order according to the sequence shown in the flowchart. For example, each step in the processing of the receiving apparatus 20 may include processing which is performed in parallel or individually (e.g. parallel processing or object processing).

Further, although the case of estimating the moving angle of the transmitting apparatus 10 that transmits a packet from one signal source is described in the embodiment, the present invention is not limited thereto. For example, the present invention may be applied also to a MIMO transceiver that performs MIMO transmission of packets from a plurality of signal sources. In this case, the receiving apparatus 20 can detect the arrival angle and the moving angle for a plurality of signal sources, and it is thus possible to detect a change in the orientation of the MIMO transceiver or the orientation of the MIMO transceiver itself.

Furthermore, it is possible to create a computer program that causes hardware such as CPU, ROM or RAM incorporated in the receiving apparatus 20 to perform the equal function to each element of the receiving apparatus 20 described above. Further, a storage medium that stores such a computer program may be provided. Each functional block shown in the functional block diagram of FIGS. 6 and 8 may be implemented by hardware, thereby achieving a series of processing on hardware.

The present application contains subject matter related to that disclosed in Japanese Priority Patent Application JP 2008-268137 filed in the Japan Patent Office on Oct. 17, 2009, the entire content of which is hereby incorporated by reference.

What is claimed is:

1. A receiving apparatus comprising:
a plurality of antennas;
a phase difference calculation unit to calculate a phase difference of a received signal between the plurality of antennas;
a difference calculation unit to calculate a difference between the phase difference of a previous received signal and the phase difference of a new received signal calculated by the phase difference calculation unit; and
a moving angle estimation unit to estimate a moving angle of a transmitting apparatus from the difference in phase difference calculated by the difference calculation unit.

2. The receiving apparatus according to claim 1, further comprising:
a signal generation unit to generate a control signal causing the transmitting apparatus to shorten a signal transmission interval if the difference in phase difference calculated by the difference calculation unit exceeds a threshold.

3. The receiving apparatus according to claim 2, wherein the signal generation unit generates a control signal causing the transmitting apparatus to maximize a signal transmission interval within a setting range if the difference in phase difference calculated by the difference calculation unit is zero.

4. The receiving apparatus according to claim 3, further comprising:
a phase detection unit to detect a phase at a maximum value with the shortest delay time among maximum values of an impulse response of a transmission channel between the transmitting apparatus and the antennas with respect to each received signal by the plurality of antennas,
wherein the phase difference calculation unit calculates a difference in the phase of each received signal by the plurality of antennas detected by the phase detection unit.

5. The receiving apparatus according to claim 4, further comprising:
a relationship storage unit to store a relationship of the difference in phase difference calculated by the difference calculation unit, a wavelength of the received signal and the moving angle of the transmitting apparatus,
wherein the moving angle estimation unit estimates the moving angle of the transmitting apparatus from the relationship stored in the relationship storage unit, the difference in phase difference calculated by the difference calculation unit and the wavelength of the received signal.

6. The receiving apparatus according to claim 5, further comprising:
an integration unit to integrate the moving angle of the transmitting apparatus estimated by the moving angle estimation unit.

7. The receiving apparatus according to claim 1, further comprising:
a signal generation unit to generate a control signal causing the transmitting apparatus to dynamically change a signal transmission interval according to a value of the difference in phase difference calculated by the difference calculation unit.

8. A moving angle estimation method comprising the steps of:
calculating phase differences of respective received signals received by a plurality of antennas;
calculating a difference between the phase difference of a previous received signal and the phase difference of a new received signal; and
estimating a moving angle of a transmitting apparatus from the difference between the phase difference of the previous received signal and the phase difference of the new received signal.

9. A program causing a computer to execute a method comprising the steps of:
calculating phase differences of respective received signals received by a plurality of antennas;
calculating a difference between the phase difference of a previous received signal and the phase difference of a new received signal; and
estimating a moving angle of a transmitting apparatus from the difference between the phase difference of the previous received signal and the phase difference of the new received signal.

10. A wireless communication system comprising:
a transmitting apparatus; and
a receiving apparatus including
a plurality of antennas,
a phase difference calculation unit to calculate a phase difference of a received signal from the transmitting apparatus between the plurality of antennas,
a difference calculation unit to calculate a difference between the phase difference of a previous received signal and the phase difference of a new received signal calculated by the phase difference calculation unit, and
a moving angle estimation unit to estimate a moving angle of the transmitting apparatus from the difference in phase difference calculated by the difference calculation unit.
